(19) United States
(12) Patent Application Publication
(10) Pub. No.: US 2017/0301253 A1
(43) Pub. Date: Oct. 19, 2017

(54) SYSTEM AND METHOD FOR PROMOTING SUSTAINABLE COMMUTING BEHAVIOR

(71) Applicant: Conduent Business Services, LLC, Dallas, TX (US)

(72) Inventor: Stefania Castellani, Meylan (FR)

(73) Assignee: Conduent Business Services, LLC, Dallas, TX (US)

(21) Appl. No.: 15/097,578

(22) Filed: Apr. 13, 2016

(51) Int. Cl. G09B 19/00; G09B 5/02

(52) U.S. Cl. CPC G09B 19/00; G09B 5/02

(57) ABSTRACT

A system, method, and device for incentivizing commuting behavior in a work environment are disclosed. The system includes a travel diary component, a profile managing component which assigns one or more difficulty metrics, a constancy computing component which recognizes a change in commuting behavior information, and a commuting points managing component which translates the change in commuting behavior information to commuting points. A visualization component displays a representation of the commuting points, for example, as plants in a virtual garden. The method includes receiving commuting behavior information, assessing one or more difficulty metrics for each of an employee profile, recognizing one or more changes in commuting behavior, correlating the one or more changes with the one or more difficulty metrics, translating the one or more changes into commuting points, and computing an aggregated value of commuting points.

### BACKGROUND

The exemplary embodiment relates to behavior modification and finds particular application in connection with a system and method for promoting sustainable commuting behavior in an organization.

Company initiatives which promote more sustainable commuting behavior of employees have recently grown in popularity. Sustainable commuting behaviors are ones that help to reduce the environmental impact of transportation usage by employees of a company or other organization. Motivation for companies to promote sustainable commuting can include building a greener brand image or being required to do so in view of environmental regulations, which may vary depending on country in which the organization is located. Typically, these initiatives take the form of so-called Workplace Travel Plans (WTP), which can be funded in part by local governments and/or companies. A WTP includes a set of incentives and policies, such as subsiding public transport passes or making electric vehicles available to the employees of the organization.

Some approaches use games to encourage the adoption of more sustainable behaviors. In particular, the EU MOBI project investigated use of the “From5To4” challenge tool to create competitions among commuters based on what is defined as “a simple formula: for every workday, one day smarter commuting.”

However, incentive systems do not recognize the efforts made by the commuters, in particular, taking into account the difficulties of the specific individual commuting contexts, the improvements of behaviors, and the constancy of the behavior changes. Thus, some employees lack the motivation to participate, or even if they do, are not rewarded for their efforts in a way which encourages continued participation.

### INCORPORATION BY REFERENCE

The following references, the disclosures of which are incorporated herein in their entireties, by reference, are mentioned:

U.S. Pat. No. 8,503,016 entitled “SYSTEM AND METHOD FOR PROVIDING ENVIRONMENTAL FEEDBACK TO USERS OF SHARED PRINTERS,” by Grasso, et al.

U.S. Pub. No. 20120033250, entitled “VIRTUAL PRINTING CURRENCY FOR PROMOTING ENVIRONMENTAL BEHAVIOR OF DEVICE USERS” by Grasso, et al.

U.S. Pub. No. 20140180651, entitled “USER PROFILING FOR ESTIMATING PRINTING PERFORMANCE,” by Lysak, et al.

U.S. Pub. No. 20150317568, entitled “SYSTEM AND METHOD FOR FLEXIBLE CARPOOLING IN A WORK CONTEXT,” by Grasso, et al.

### BRIEF DESCRIPTION

In accordance with the exemplary embodiment, an incentive system and method to reward the employees of a work organization for their more sustainable behaviors in commuting in a workplace takes into account the difficulty of the behavior changes in commuting for the employees of the work organization. That is, the behavior changes are weighted with respect to the actual capabilities and constraints of the commuters making the behavior change. Thus, the system accounts for the feasibility of a given commuter in making a behavior change, and not just their ability to make a behavior change. “Soft” changes, that is, improvements in commuting behavior that cannot yet be considered changes are taken into account. In addition changes of commuters towards more sustainable commuting behaviors, and the constancy of the change, is recognized. Finally, the visual representation of commuting behaviors of employees of a work organization, and in particular of the changes of behavior and their constancy, is displayed, e.g., as the evolution of a virtual garden associated to the workplace and its employees.

In accordance with one aspect of the exemplary embodiment, a system for incentivizing commuting behavior includes memory which stores at least one difficulty metric for each of a plurality of users. A travel diary component stores commuting behavior information received for the plurality of users. A constancy computing component recognizes a change in the commuting behavior information for one of the users and computes a constancy of the change. A commuting points managing component awards commuting points for the user as a function of at least one of the difficulty metrics and the constancy of the change. A visualization component generates a visual interface for displaying a representation of the commuting points for at least one of the users. A processor implements the travel diary component, the constancy computing component, the commuting points managing component, and the visualization component.

In another aspect of the exemplary embodiment, a method for incentivizing commuting behavior in a work environment includes receiving commuting behavior information related to a work environment and logging the commuting behavior in a memory over a period of time. One or more difficulty metrics are assessed for each of an employee profile stored in a database of employee profiles. One or more changes in commuting behavior are recognized. The one or more changes are correlated with the one or more difficulty metrics. A constancy of the one or more changes is then computed. The one or more changes are translated into commuting points having a value based on the correlating of the one or more changes with the one or more difficulty metrics and the constancy of the one or more changes. An aggregated value of commuting points is then computed over the period of time. An interface for visualizing the aggregated value of commuting points at a current time is generated, and on the interface, the aggregated value of commuting points is visualized over the period of time.

One or more of the steps of the method may be implemented by a computer processor.

In accordance with another aspect of the exemplary embodiment, a method for promoting positive commuting behavior in a work environment includes collecting information related to commuting behavior of at least one commuter commuting to a work environment. The information related to commuting behavior of the at least one commuter is logged in a memory over a period of time. A set of criteria for measuring a commuting difficulty of each of the at least one commuter is assessed and stored in the memory. A means for updating the set of criteria is also provided. One or more changes in the commuting behavior of each of the at least one commuter is recognized, and the one or more changes are translated into a point value based on the set of criteria for measuring the commuting difficulty. A constancy of the one or more changes is assessed and the constancy is translated into a point value based on the set of criteria for measuring the commuting difficulty. For each of the at least one commuter, the point value of the one or more changes and the point value of the constancy are aggregated into an aggregated point value over the period of time. The aggregated point value for each of the at least one commuter is output.

One or more of the steps of the method may be implemented by a computer processor.

### BRIEF DESCRIPTION OF THE DRAWINGS

FIG. 1 is a functional block diagram of an environment in which a system for incentivizing commuting behavior to a work place operates;

FIG. 2 is a flow chart illustrating a method for incentivizing commuting behavior in accordance with another aspect of the exemplary embodiment; and

FIG. 3 illustrates generation of a representation of aggregated points awarded to users.

### DETAILED DESCRIPTION

Aspects of the exemplary embodiment relate to a system and method which aim to provide an organization with mechanisms to represent and acknowledge positive behaviors in the commuting of personnel, and to reward people in a contextualized and fairer way.

The term user is used herein to refer to the people that are part of an organization, such as the workforce of a company, volunteers of a charitable organization, government employees or contractors, and so forth. The term user is used interchangeably with terms such as employees and commuters.

Positive commuting behaviors of users are ones that help reduce the environmental impact of their transport activity, such as using public transport instead of driving a personal car, which in turn helps reduce the environmental impact of an organization in terms of the whole transport activity that the organization generates. As a result, employees are motivated to have more environmentally-conscious commuting behaviors and companies are motivated to invest in rewarding such behavior. One effect of the aggregation of individual employee behavior improvements is the resulting improvement of company brand image.

Positive commuting behaviors of employees are rewarded by awarding them commuting points. The rewards are contextualized to the effective possibilities that each individual employee has to improve their behaviors and to maintain the positive behaviors that have already been adopted. In other words, positive commuting behaviors are rewarded taking into account individual constraints that the commuters may have, either at work, in private life, or in the transport infrastructure to which commuters have access.

In some embodiments, the system can take into account, for a given employee commuting to work, that using public transport to reach the workplace is difficult, for example, because the time taken is too long, because the worker has personal constraints on his or her time, or because the work shifts are not compatible with public transport timetables. In some embodiments the system takes into account changes from a positive behavior to a negative one, where external factors do not oblige the commuter to adopt a negative behavior. In some embodiments, constancy in maintaining positive behaviors is rewarded.

In some embodiments, the system is able to recognize and reward soft changes, such as driving less nervously and therefore consuming less fuel, or an intention to change toward a more sustainable transportation mode. An improvement goal can also be set as a soft change, wherein recognized steps toward achieving the goal show an intention to change towards an improvement in behavior.

The commuting behaviors and changes are captured in a global representation of commuting habits for the workplace. The representation may include a visualization, such as the evolution of plants in a virtual garden that is associated to the workplace.

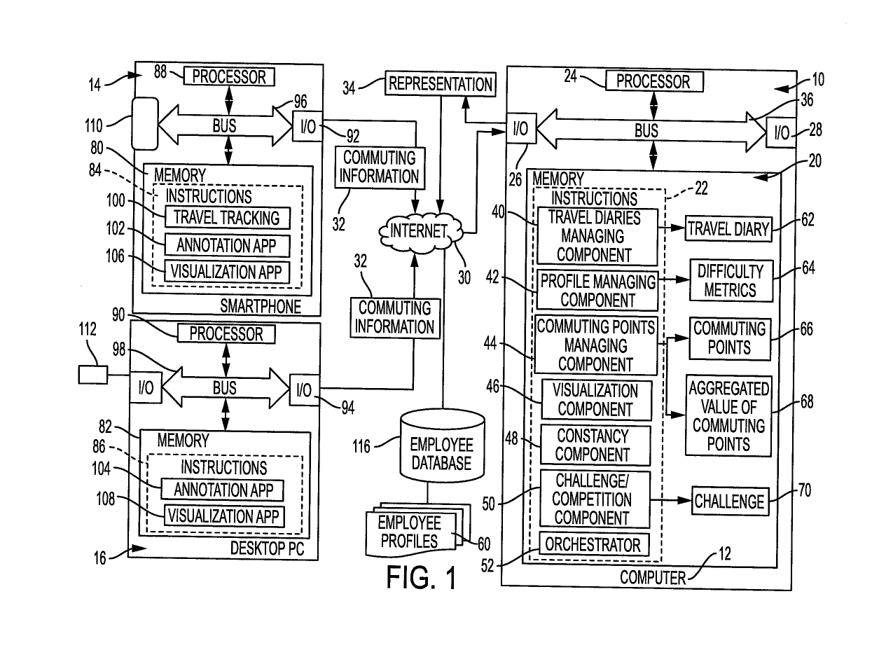

With reference to FIG. 1, an environment in which an exemplary computer-implemented system 10 for incentivizing commuting behavior in a work environment is illustrated. The system 10 includes a server 12 which communicates with user interface devices 14, 16, etc.

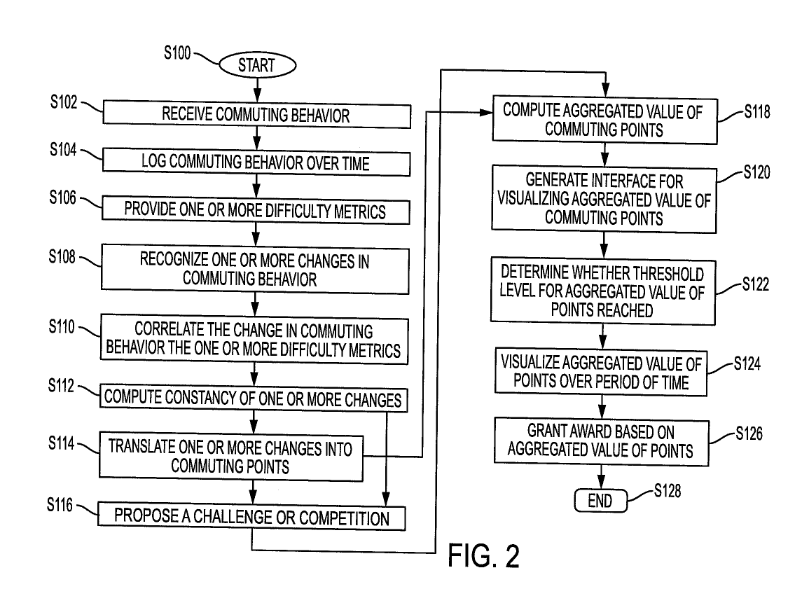

The system 10 includes memory 20, which stores software instructions 22 for performing the method described with reference to FIG. 2, and a processor device 24 in communication with the memory for executing the instructions. One or more network input/output (I/O) interfaces 26, 28 are provided for communicating with external devices, such as devices 14, 16, via a wired or wireless network 30, such as a local area network, or a wide area network, such as the Internet. The system may thus receive information 32 related to employees' commuting behavior and outputting information, such as a representation 34. Hardware components 20, 24, 26, 28 of the system communicate via a data control bus 36.

The system 10 provides for the collection, aggregation, and display of the relevant commuting information 30 and information extracted therefrom.

The illustrated instructions 22 include a travel diary managing component 40, a profile managing component 42, a commuting points managing component 44, a visualization component 46, a constancy component 48, and optionally a challenge/competition component 50 and an orchestrator 52.

The travel diary managing component 40 receives and evaluates employees' commuting behavior related to a work environment, which can include commuting modalities used (e.g., method of transportation, travel times, driving style for motorized vehicles, and the like), which may be stored, for each employee, in an employee profile 60, e.g., in a travel diary 62. The travel diaries managing component 40 may automatically or semi-automatically build a personalized travel diary 62 of the commuter-published transportation habits, for each user-employee, based the commuting behavior information 30 output by the user devices 14, 16.

The profile managing component 42 assigns difficulty metrics 64 to one or more employees and stores the difficulty metrics 64 in memory, e.g., in the respective user profiles 60. The profile managing component 42 assesses the difficulty that employees face when commuting to their respective work organization. In some embodiments, several difficulty metrics may be combined to generate a single difficulty metric 64 for each employee.

The commuting points managing component 44 translates a detected change in commuting behavior information 32 into commuting points 66. In doing so, the commuting points managing component 44 correlates any change in commuting behavior to the one more difficulty metrics 64 assigned by the profile managing component 42.

The visualization component 46 generates a graphical user interface for displaying the representation 34 of an aggregated value 68 of commuting points. The representation 34 can be in the form of a virtual garden, or “Commuting Garden.” This representation can be displayed to the employee corresponding to the employee profile 60, or can be displayed to all or a subset of the employees of the work organization.

The constancy computing component 48, evaluates whether a behavior change is maintained. The constancy computing component 48 may access the travel diary 62 of each employee at intervals. Based on the travel diary information, the constancy computing component 48 recognizes a change in the commuting behavior information and computes a constancy of the change. A change in commuting behavior can refer to a positive change, which is a change that helps to reduce the environmental impact of transport activity. For example, an employee may decide to use a public transport means (e.g., metro, bus, train) or carpool with other employees instead of driving a personal car. In turn, the positive change helps reduce the environmental impact of work organization in terms of the whole transport activity that it generates via its employees. Conversely, a change in commuting behavior can refer to a negative change where an employee reverts back to driving a personal car instead of using a more environmentally friendly transport mode.

The challenge/competition component 50 generates a challenge 70 for display to one or more employees which is intended to encourage behavior change or maintenance of a behavior change.

Optionally, the orchestrator 52 calls on the other components to perform their respective tasks.

The user interface devices 14, 16 are operated by employees and may include smartphones, tablet computers desktop PC's and the like, for interacting with the system 10. The user devices 14, 16 send information 32 related to the commuting behavior of respective employees to the system, which is processed by the travel diaries managing component 40. The information 32 may be manually generated by the employee and/or automatically generated by the user device.

As for the system computer 12, each user device 14, 16 includes memory 80, 82 which stores instructions 84, 86 for performing aspects of the method described with reference to FIG. 2, and a processor device 88, 90 in communication with the memory, for executing the instructions. One or more network input/output (I/O) interfaces 92, 94, are provided for communicating with external devices, e.g., for outputting commuting behavior information 32 from the respective user devices 14, 16. Hardware components 80, 86, 92, and 82, 90, 94 of each device communicate via a respective data control bus 96, 98. The user devices 24, 32 may communicate with each other and/or server computer 12, via the wired or wireless network 30, such as a local area network, or a wide area network, such as the Internet, or a wired or wireless detector such as Bluetooth, Wi-Fi, near field communication (NFC), and the like.

Mobile user devices, such as smartphone 14 can include a travel tracker component 100 which automatically tracks information related to commuting behavior. The travel tracking component may include or communicate with one or more tracking devices, such as transportation mode detectors, driving style detectors, global positioning system (GPS) receivers, accelerometers, g-sensors, gyroscopes, pedometers, and/or other common sensors and detectors useful for detecting movement. These inertial sensors and detectors measure various aspects of a user's commuting behavior, including but not limited to, distance traveled, duration of travel, speed, acceleration, braking events, turning events, and the like. This information can be generated automatically as a user-employee commutes to his or her workplace and collected as part of the commuting behavior information 30. An exemplary method for detecting driving style can be found in Van Ly, et al., “Driver Classification and Driving Style Recognition using Inertial Sensors”, 2013 IEEE Intelligent Vehicles Symposium (IV), Jun. 23-26, 2013. In some embodiments, the travel tracking component 100 is included in a smartphone application or software on user device 14.

All user devices 14, 16 may include an annotation component or application 102, 104, and a visualization component or application 106, 108. Annotation components 102, 104 permit employees to enter and/or annotate their information related to commuting behavior. The annotation component 102, 104 is utilized by the user-employee commuting to work to provide annotations on their respective commuting behavior 30. The annotation component 102, 104 can be provided to employees on one or more user devices, such as smartphone 14 and desktop PC 16, and can be utilized to edit or supplement commuting behavior information 30 automatically gathered by the travel tracking component 100, if available. For example, employees can use the annotation components 102, 104, to change incorrect information or to select which commuting information is sent to the server 12. For example, users can provide information such as their commuting modality on a particular day, the fact that the user car-pooled with other colleagues, or weather conditions. The annotation component 102, 104 can also be utilized to select which information an employee sends to the server 12. For example, an employee may wish to publish her commuting modality that day, but not the time or with whom she commuted.

Visualization components 106, 108 display the representation 34 of a respective employees' aggregated value of commuting points. The visualization application 106, 108 can be in the form of a widget or mobile application which causes the representation to be displayed on a display device 110, 112, such as an LCD screen, LED screen, computer monitor, or the like. Each user device may also include a respective user input device, such as a touch screen, keyboard, keypad, cursor control device, or combination thereof. Visualization component 106, 108 may also generate an interface for accessing and viewing the information gathered by the travel tracking component 100 and annotated by the annotation component 102, 104. In some embodiments, the visualization component 106, 108 is in the form of a widget which is always accessible and visible to the commuter on her respective user device 14, 16. The visualization component can display “live” information gathered from the travel tracking component 100 while the employee is commuting to the workplace. The visualization component 106, 108 can also display summarized commuting information 30 for a particular day or for a particular period of time, such as the commuting information gathered over the past week, month, year, etc.

Only two user devices 14, 16 are shown for ease of illustration, but it is to be appreciated that a large number of such user devices may be linked to the server 12.

The commuting information 32 can be input from any suitable source 14, 16 such as a smartphone, desktop PC workstation, database, memory storage device, such as a disk, flash memory, or the like and may be stored in memory 20 during processing. The commuting information 32 may be automatically captured by travel trackers 100 and/or manually provided by annotation components 102, 104.

The employee profiles 60 may be stored in a database 116 of employee profiles. The database 116 of employee profiles may be generated in an off-line phase by assessing the difficulty each employee in a work organization faces in the context of commuting to and from work. In some embodiments, a person, such as a human resources manager responsible for sustainability initiatives in the work organization develops each of the employee profiles 60 in the database 116. In other embodiments, the profile managing component 42 utilizes the demographic, administrative, and geographic information related to each employee and already owned by the work organization to develop the employee profiles 60. Such information may be referred to as and contained in a workplace travel plan (WTP).

It is assumed that the employees of an organization have available to them a variety of modes of transport, such as bus, train, tram, car, bicycle, walking, and combinations thereof. Each transportation mode is associated with a sustainability measure which is based on the impact of the transportation mode on the environment. Such information may be acquired from publicly available resources and may be based on one or more factors, such as consumption of non-renewable resources per distance traveled, pollution output, e.g., in terms of CO₂ emissions, maintenance costs of the transport, and the like. In other embodiments the transportation modes may be ranked based on expected environmental impacts. Shared transportation may be measured/ranked accordingly. Not all transport modes may be available to all employees, and some employees may face greater difficulties in using a particular mode or modes of transport than others. The difficulty each employee faces in commuting to and from work is noted in each employee's respective profile 60. The difficulty metrics 64 may be derived from a number of criteria which can be developed by an administrator of the system 10, such as a human resources manager of the work organization.

Exemplary difficulty metrics may include one or more of a personal life metric, a distance metric, a work constraint metric, a transportation metric and a weather metric. The personal life metric can be assessed by criteria which take account of the fact that a commuter has one or more children or other family members who he or she has to take care of, such as a young child that the commuter brings to school on her way to the workplace in the morning. This metric may also take into account personal disabilities which make it unfeasible for an employee to walk more than a certain distance.

The distance metric may be based on criteria which account for the long or short distance between the commuter's home and her workplace. For example, a commuter that lives farther than a given threshold physical distance from the workplace faces a greater commuting difficulty than a commuter living at a distance less than or equal to the given threshold. Additionally, employees that live very close to the workplace may not be able to reduce their environmental impact if they already walk to work.

The work constraint metric takes into account the work schedule of some employees. For example, a commuter may have rigid work shifts or variable times causing that commuter's schedule to be incompatible with public transport timetables.

The transportation metric can factor in whether there is limited transport availability, such as where the commuter does not have easy access to public transport (e.g., the first available bus stop is 2 kilometers from her home).

The weather metric may take into account weather conditions, to account for inclement weather conditions such as a high frequency or rainy days in a particular region or at certain times of the year which may make certain transportation modes available.

The system administrator can assign a default level for each of the difficulty metrics 64, which may each have a range defined between upper and lower threshold values (or in some cases, to meet only an upper or a lower threshold value). For example, a distance metric can be scaled between a “close-by” constraint or threshold (e.g., 0-5 km, or lower than 5 km) and a “far away” threshold (e.g., 30-40 km, or above 30 km). The system administrator then “scores” each employee with respect to each of the difficulty metrics 64, optionally using the demographic, administrative, and geographic information stored in each employee profile 60. The scale and scores for each employee can then be refined/validated for each difficulty metric 64 as necessary. For example, the administrator of the system can adapt the difficulty metrics to different situations and changes of context. This may be the case when changes occur in the external transport infrastructure, such as the creation of a new bus line, or at the workplace, such as a fleet of electric vehicles being made available by the work organization to its employees. The profile managing component 42 can thus assign and update these difficulty metrics 64 for each of the employee profiles 60 stored in the database 116 of employee profiles.

The constancy computing component 48 computes constancy based on a number of criteria which can be developed by an administrator of the system 10. Some examples of constancy criteria include reaching a significant amount of occurrences of the events corresponding to positive changes in commuting behavior over a predetermined period of time. For example, a changed commuting behavior such as changing from car usage to bicycle usage or car-sharing may occur for least once a week for the last four weeks before it is recognized as a constant change. Another constancy criterion includes maintaining a positive commuting behavior change even after a change in life that typically triggers behavior change towards the use of a car. For example, an employee may move or have a child but continue to commute via bicycle as opposed to by car. The system administrator can assign a default scaled level for the constancy criteria within a certain range defined between upper and lower threshold values (or in some cases, to meet only an upper or a lower threshold value).

The commuting points managing component 44 translates the change in commuting behavior recognized by the constancy computing component 48 to commuting points 66. The amount of commuting points 66 awarded can be a function of one or more of: the actual change itself, the one or more difficulty metrics 64 correlated to the change, and the constancy of the change in commuting behavior. The commuting points 66 are awarded to employees logging changes in commuting behavior that are positive. The initial value of commuting points 66 may be set by the system administrator, and can depend in part on the commuting values of the company. For example, a single “positive change” in commuting behavior may correspond to a point value of “1.” If desired, different point values can be used for different changes, such as where a company or work organization values one commuting mode over others (e.g., biking over car). Accordingly an initial point value corresponding to a commuting change to biking can be set at a value higher than “1,” such as “2” or more. By correlating the commuting points to the one or more difficulty metrics 64 assigned to each individual employee in their respective profile 60, the changes in commuting behavior can be weighted with respect to the difficulty constraints that the commuters may have, either at work, in private life, or in the transport modes to which commuters have access. Accordingly, a difficulty metric which represents a challenging change for a particular commuter may be weighted to give a higher value of commuting points. A change to a positive commuting behavior may also be rewarded based on the constancy of the change. The commuting points 66 can be awarded by the commuting points managing component 44 over a set period of time (e.g., one week, one month, one year, etc.). Over the set period of time, an aggregated value 68 of commuting points may be collected by each participating employee or group of employees. The system administrator can assign a threshold for commuting points or a period of time in which commuting points can be aggregated. Once an employee's aggregated value of commuting points exceeds the threshold, or the period of time expires, the commuting points managing component 42 can return the point value to zero. The commuting points managing component 42 manages the aggregated values of commuting points and stores them in memory 20 along with each employee's travel diary 62.

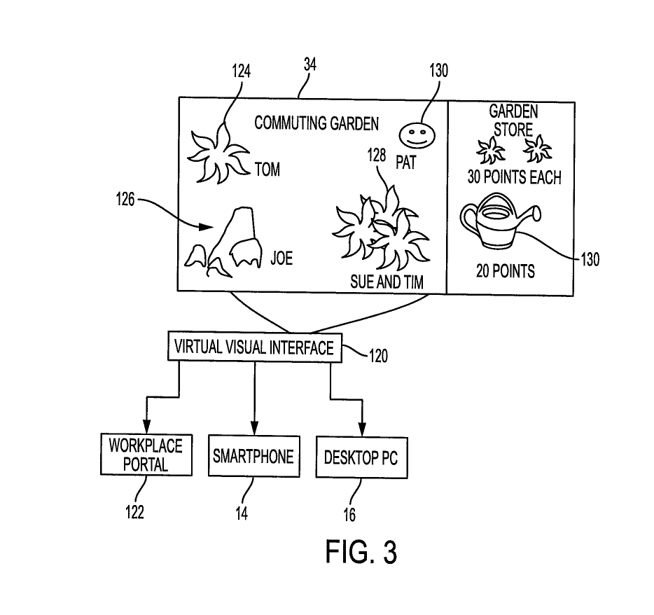

The visualization component 46 generates a graphical representation 34 for displaying a representation of the aggregated value of commuting points via a GUI. In some embodiments, a visual interface 120 can be generated on a workplace portal 122 in communication with the system, as illustrated in FIG. 3. The visual interface 120 generates a representation 34 of a virtual garden. The employees can use their accumulated points to acquire living things, e.g., plants 124, 126, 128 for the virtual garden and water 130 or other nutrients to maintain their plants. Plants 126 that do not receive regular nutrients wither and die. This may occur if employees do not maintain their positive behavior and thus do not receive points for constancy which can be used for purchase of nutrients. The representation of commuting points can be accessed and displayed at any time by any authorized employee, such as one having an employee profile at the work organization.

The visualization component 46 may generate the virtual visual interface 120 on a respective display device via the workplace portal 122, such as an LCD/LED screen, computer monitor, or the like, which an employee can interact with via a respective user input device, such as a touch screen, keyboard, keypad, cursor control device, or combination thereof.

The visualization component 46 can display, via a single representation 34, a living thing, such as plant or plants to represent each of the commuters who adopted a positive commuting behavior contributing to the improvement of the work organization's sustainable commuting global picture. Optionally, the visual interface 120 can display an employee's name for each of the employee's respective plants, thus permitting public recognition of positive changes in commuting behavior and achievements reached over time. The visual interface 120 can further display placeholders 128 allocated for plants to represent an objective set up by a commuter, such as an objective to ride a bicycle to work instead of driving a personal car.

The visualization component 46 also displays the creation of new plants, the provision of doses of water or fertilizer, and/or the appearance of flowers and then fruits to represent the acquisition of points beyond the default threshold set by the system administrator. Conversely, the visualization component 22 can display a decaying plant representing the failure to acquire new or additional commuting points in a given time frame. In this regard, the visualization component 46 can periodically communicate with the commuting points managing component 44 to determine whether the threshold level of commuting points has been reached. The threshold level of commuting points can be any desired number set by the system administrator.

In some other embodiments, the visualization component 46 may generate the virtual visual interface 120 on a respective display device of the smartphone 14 or desktop PC 16, such as an LCD/LED screen, computer monitor, or the like, and a respective user input device, such as a touch screen, keyboard, keypad, cursor control device, or combination thereof. The visual interface 120 can be displayed via a widget which is always available and visible to the commuter-employee on her device 14, 16 via visualization component 106, 108. The widget displays the plant 124 representing the user's aggregated value of commuting points, if any, which corresponds to her contribution to a collective Commuting Garden. The widget can also display the doses of water and fertilizer that she has been granted. The widget can also permit the user to choose if and when to give the granted doses of water and fertilizer to her plant.

In some embodiments, the visualization component can generate different types of plants and display them on the visual interface 120, the different types of plants having varying levels of difficulty in managing. Such plants represent difficult contexts of commuting. In other words, a difficult to manage plant can represent an employee-commuter facing a difficult commute based on the values of the difficulty metrics 64 assigned to that respective employee's profile 60. The level of difficulty in managing various plants can be decided by the system administrator.

In some embodiments, the representation may be based on the commuting points aggregated by a group of employees. For example, groups of commuters that participate in ride-sharing on a regular basis, such as car-sharing or car-pooling, may be represented as flowerbeds 128. If a particular commuter participates in ride-sharing with several groups, then the visual interface 120 may display that commuter's respective plant in the flowerbed associated with the group where she most participates.

The visualization component 46 thus transforms aggregated commuting points 68 into a visual interface 120 for displaying virtual plants 124, 126, 128 in a virtual garden. The various plants in the garden represent the aggregated value of commuting points obtained by each employee or each group of employees. The plants that get water and fertilizer grow, representing persistence of positive commuting behaviors. The plants that do not get water or fertilizer do not grow or become unhealthy, representing negative commuting behavior. If enough negative commuting behavior occurs, the plant “naturally” dies and a representation of the plant as a past plant is stored in memory 20 or in a respective employee profile 60.

Transportation activity has previously been represented with a tree, flowers, and fruits which re-initialize weekly in the “Ubigreen” mobile tool. See Froehlich, et al., “UbiGreen: Investigating a Mobile Tool for Tracking and Supporting Green Transportation Habits,” Proc. CHI 2009 Conf. Plants with leaves have been used to represent the consumption of resources and production of CO₂ associated with the print activity of an employee. See U.S. Pat. No. 8,503,016 to Grasso, et al. A garden metaphor has also been used to represent a week's worth of physical activity behavior. See, Kazhamiakin, et al. “Using Gamification to Incentivize Sustainable Urban Mobility”, 1st IEEE Intl Smart Cities Conf. (ISC2), October 2015. In the exemplary system 10, the visualization component 46 displays different kinds of plants, and a plant's lifecycle is persistent and follows the long-term behaviors and habits of the commuters using the system.

Optionally, the challenge/competition component 50 can be utilized to propose a challenge 70 to an individual employee or a group of employees, based on their respective profile(s) 60 stored in the database 116. For example, challenges can be set up by the system administrator and presented by the challenge/competition component 50 to the commuter. Such a challenge could be presented if the commuter has not set any objective for positively changing commuting behavior. Challenges can also be presented if the challenge/competition component 50 detects that an improvement is possible given the commuting information 32 being received by the travel diaries managing component 40. Any challenge 70 presented to the employee can then be accepted or declined. The individual employee or group of employees may also decide to set up their own challenge.

The challenges proposed by the challenge/competition component 50 to the commuter can consider the level of difficulty of changes in commuting habits for the user. The challenge/competition component 50 may obtain the difficulty metrics 64 assigned to each employee profile 60 before presenting a particular challenge. For example, a challenge to use only a bicycle for commuting may not be proposed to somebody living over a given distance (e.g., 25 kilometers) from her workplace. The commuting points managing component 44 awards commuting points 66 upon an employee's successful completion of a challenge. The value of commuting points for completing a challenge can be set by the system administrator. Some challenges may have an initial value (e.g., 10 or more) that is worth more than other challenges or more than other single positive commuting behavior changes. In this regard, the challenges presented by the challenge/competition component 50 may assist in motivating positive commuting behaviors among the employees of the work organization.

The challenge/competition component 50 can also be utilized to organize competitions among employees of the work organization or among work organizations in the same geographical region, e.g., at a specific time of the year. The commuting points managing component 44 can then award commuting points 66 as a prize for winning work organizations and its employees.

The system 10 may be resident on one or more computing devices 12, such as a PC, such as a desktop, a laptop, palmtop computer, portable digital assistant (PDA), server computer, cellular telephone, tablet computer, pager, combination thereof, or other computing device capable of executing instructions for performing the exemplary method. As will be appreciated parts of the system 10 may be distributed over two or more computing devices.

The memory 20, 80, 82 may represent any type of non-transitory computer readable medium such as random access memory (RAM), read only memory (ROM), magnetic disk or tape, optical disk, flash memory, or holographic memory. In one embodiment, each memory comprises a combination of random access memory and read only memory. In some embodiments, the processor and respective memory may be combined in a single chip.

The network interfaces 26, 28, allow the computer 12 to communicate with other devices via a wired or wireless link, such as a computer network, such as a local area network (LAN) or wide area network (WAN), or the Internet, and may comprise a modulator/demodulator (MODEM) a router, a cable, and and/or Ethernet port.

The digital processors 24, 88, 90 can each be variously embodied, such as by a single-core processor, a dual-core processor (or more generally by a multiple-core processor), a digital processor and cooperating math coprocessor, a digital controller, or the like. The digital processor, in addition to controlling the operation of the respective computer 12 or user device 14, 16, executes instructions stored in memory for performing the method outlined in FIG. 2.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

With reference now to FIG. 2, a method for incentivizing commuting behavior in a work environment, which can be performed with the system of FIG. 1, is illustrated.

The method begins at S100.

At S102, commuting behavior information 32 related to commuting behavior of commuters commuting to a work environment is received by component 40.

Commuters may provide a selected part of their commuting information 32 to the travel diaries managing component 40 of system 10. The information can be communicated using the one or more user devices 14, 16 when employees arrive at work in the morning, for example. The “selected part” of the commuting information refers to the employee being able to configure which commuting information the employee wants to publish to the system 10 via the annotation component 102, 104. The desired commuting information 30 is selected from the set of available information captured by the travel tracking component 100. The annotation component 102, 104 may also be utilized to communicate an objective of an individual commuter to make a positive commuting behavior change, which is received by component 40.

At S104, the commuting behavior information is logged over a period of time. The period of time can correspond to any desired period of time, such as the work organization's quarterly calendar, different seasons, a month-to-month basis, etc. A travel diary 62 of the transportation habits made available by the commuter is built with the logged information over this period of time. The logged commuting behavior is stored in memory 20.

At S106 one or more difficulty metrics 64 are provided and made accessible to the profile managing component 42. The difficulty each employee in a work organization faces is assessed in the context of commuting to and from work. A number of criteria can be developed by an administrator of the system 10 to define the one or more difficulty metrics 64, as described above. The difficulty metrics are stored in memory 20 for each employee, such as in employee profile 60, and may be updated based on any subsequent refining or validation. The difficulty metrics may be subsequently refined based on a triggering event, such as a move further from work, increase in personal responsibilities, health challenges, changes in work schedules, changes in available transportation modes, and so forth.

At S108, one or more changes in commuting behavior are recognized based on the logged commuting behavior information 62. In particular, positive changes in commuting behavior are detected including one or more of: using sustainable transportation modes (e.g., walking, car-sharing, bicycling, public transport), changing transportation modes from a single occupancy vehicle (SOV) to a sustainable transportation mode, and constancy in the usage of sustainable transportation modes. The changes are recognized from the commuting information 32 collected and annotated by user devices 14, 16, received by the travel diaries managing component 40.

At S110, the one or more changes in commuting behavior are correlated with the one or more difficulty metrics for the user. The one or more changes made by a commuter may thus be weighted by one or more of difficulty metrics 64 so that a higher value is placed on changes which are more difficult to achieve than others.

At S112, a constancy of the one or more changes in commuting behavior is computed.

At S114, the one or more changes in commuting behavior are translated into commuting points having a value based on the correlating of the one or more changes with the one or more difficulty metrics from S110. In some embodiments, the one or more changes can have a set point value, defined by the system administrator, and based on the type of change itself. The constancy of the one or more changes can also affect commuting point value. The commuting points 66 are awarded to employees logging changes in commuting behavior that are positive. By correlating the commuting points to the one or more difficulty metrics 64 assigned to each individual employee in their respective profile 60, the commuting behavior changes are weighted with respect to the difficult constraints that the commuters may have. Accordingly, a difficulty metric which represents a challenging change for a particular commuter is typically weighted to have a higher commuting point value.

In some embodiments, commuting points 66 are awarded when commuters use sustainable transportation modes such as walking, car sharing, bicycling, public transport based modes, etc. In particular embodiments where commuting points are awarded for car-sharing, commuting points are given to both the driver of the car and the passengers for each ride that they share. The driver can receive a higher number of points per ride, and additional points for the number of passengers in the car, thus acknowledging the effort of making her car a resource available to others (e.g., her colleagues). In other embodiments, commuting points can be awarded when the change in commuting behavior is a switch from a SOV transportation mode to a more sustainable transportation mode. In further embodiments, commuting points are awarded for constancy in the usage of sustainable transportation modes. Constancy refers to awarding commuting points based on a persistent change made for a set period of time, such as for one week, one month, etc. For example, a commuter may switch from car usage to bicycle usage or car-sharing for at least once a week for the last four weeks.

In some additional embodiments, commuting points 66 are awarded for “soft changes.” Soft changes are those which indicate a willingness to adopt a more sustainable commuting behavior. For example, commuting points are accumulated by SOV car drivers who change their current driving style to a less energy consuming one, which can be recognized by travel trackers 100. Soft changes can also be rewarded with commuting points when commuters set an objective to move to a more sustainable transport habit. For example, for a given percentage of trips over a given time period, a commuter increases the usage of public transport. Additional commuting points are then granted to the commuter when the objective is reached.

For each of the achievements or changes in commuting behavior, the number of commuting points awarded takes into account the difficulty of the achievement or change. Thus, more points are given to the commuters for whom the achievements are “more difficult” to achieve than for others.

At S116, a challenge or a competition is optionally proposed to one or more employees based on the one or more employee profiles. Commuting points are awarded based on the acceptance and completion of a challenge or competition. Again, the point value awarded is weighted against the one or more difficulty metrics.

At S118, an aggregated value of points based on the one or more changes in commuting behavior is computed over a period of time.

At S120, an interface for visualizing the aggregated value of points at a current time is generated. A representation of the aggregated value of commuting points is displayed and can be accessed at any time and by any employee having an employee profile at the work organization. The visualization can be displayed on the visual interface at any one of the workplace portal, smartphone, or desktop PC. The visualizing includes representing the aggregated value 68 of commuting points as a virtual garden, as described above.

At S122, the system determines whether a threshold level for the aggregated value of points has been reached.

At S124, the aggregated value of points are output and visualized over a period of time. Employees are awarded commuting points over time, and as the points aggregate toward the threshold level, the visualization changes. Reaching a threshold level is representative of persistence in positive commuting behavior. Accordingly, persistent positive commuting behavior causes “positive” visualizations over time, such as causing the virtual plant to grow, the creation of new plants, the provision of doses of water or fertilizer, and/or the appearance of flowers and then fruits. The growth lifecycle of the virtual plant can be correlated to the growth lifecycle of the actual plant represented by the virtual plant, if desired. Failing to reach the threshold level, or failing to continue accumulating points toward the threshold level, is representative of a negative commuting behavior. Accordingly, a negative commuting behavior causes “negative” visualizations over time. For example, the interface displays a decaying plant as the commuter fails to acquire new or additional commuting points over a period of time.

At S126, an award is granted based on a condition of the aggregated value of points. In some embodiments, the condition is the reaching of the threshold level for the aggregated value of points as determined in S122. The award is generally derived from the social recognition achieved through the visualization of a user's aggregated commuting points. In some other embodiments, when the threshold is reached, the award can be a tangible one such as an award of a real plant, flower, or fruits. The award can also correspond to the benefits in the organization, such as a higher priority in a classification for giving access to electric vehicle facilities when made available to the commuters.

The method ends at S128.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method for visualizing performance data.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A system for incentivizing commuting behavior comprising:
memory which stores at least one difficulty metric for each of a plurality of users;
a travel diary component which stores commuting behavior information received for the plurality of users;
a constancy computing component which recognizes a change in the commuting behavior information for one of the users and computes a constancy of the change;
a commuting points managing component which awards commuting points for the user as a function of at least one of the difficulty metrics and the constancy of the change;
a visualization component which generates a visual interface for displaying a representation of the commuting points for at least one of the users; and
a processor which implements the travel diary component, the constancy computing component, the commuting points managing component, and the visualization component.

2. The system of claim 1, wherein the system communicates with associated user devices which send information related to the commuting behavior to the travel diary component.

3. The system of claim 2, wherein the associated user devices include computing devices selected from smartphones and personal computers.

4. The system of claim 2, wherein at least a part of the commuting behavior information includes information acquired by a travel tracker component of the user device, which automatically tracks information related to commuting behavior.

5. The system of claim 2, wherein at least a part of the commuting behavior information includes annotations of the information related to commuting behavior provided by a user of the associated device.

6. The system of claim 1, wherein the at least one difficulty metric is selected from the group consisting of a personal life metric, a distance metric, a work constraint metric, a transportation metric, a weather metric, and combinations thereof.

7. The system of claim 1, wherein the representation is a virtual garden having a plant to represent the commuting points of each of the users, wherein the plant exhibits a response based on the commuting points awarded by the commuting points managing component.

8. The system claim 7, wherein the visual interface displays a flowerbed in the virtual garden to represent the commuting points of a group of users.

9. The system of claim 7, wherein the visualization component generates the virtual garden on associated user devices including computing devices selected from smartphones and personal computers.

10. A method for incentivizing commuting behavior in a work environment comprising:
receiving commuting behavior information for a plurality of users and logging the commuting behavior in a memory over a period of time;
recognizing a change in commuting behavior for a user, based on the commuting behavior information;
correlating the change in commuting behavior with at least one difficulty metric associated with the user in memory;
computing a constancy of the change in commuting behavior;
awarding commuting points for the user as a function of at least one of the difficulty metrics and the constancy of the change;
generating a visual interface for displaying a representation of the commuting points for at least one of the users;
wherein at least one of the recognizing the change, correlating the change, computing a constancy, awarding commuting points, and generating the visual interface is performed with a processor.

11. The method of claim 10, wherein the change in commuting behavior is selected from the group consisting of: selecting a more sustainable transportation mode, using a sustainable transportation mode persistently over a period of time, changing a driving style, participating in a challenge or a competition, and combinations thereof.

12. The method of claim 10, further comprising adapting at least one of the difficulty metrics to account for changes in a transportation infrastructure or a work environment.

13. The method of claim 10, further comprising proposing a challenge or a competition based on one or more user profiles which each store the difficulty metric associated with the respective user.

14. The method of claim 10, wherein the displaying further comprises representing the commuting points as one or more virtual plants in a virtual garden which exhibit a response to a persistence in positive commuting behavior over the period of time.

15. The method of claim 14, wherein the representation is selected from the group consisting of: creating a new virtual plant in the virtual garden, provisioning of doses of water or fertilizer, creating flowers and then fruits on the one or more virtual plants in the virtual garden, and combinations thereof.

16. The method of claim 14, wherein the one or more plants in the virtual garden exhibit a response to a failure to maintain positive commuting behavior over the period of time.

17. A computer program product comprising a non-transitory storage medium storing instructions, which when executed by a computer, perform the method of claim 10.

18. A system comprising memory which stores instructions for performing the method of claim 10 and a processor in communication with the memory for executing the instructions.

19. A method for promoting positive commuting behavior in a work environment comprising:
collecting information related to commuting behavior of at least one commuter commuting to a work environment;
logging the information related to commuting behavior of the of at least one commuter in a memory over a period of time;
assessing a set of criteria for measuring a commuting difficulty of each of the at least one commuter and storing the set of criteria in the memory;
providing for updating the set of criteria;
with a processor, recognizing one or more changes in the commuting behavior of each of the at least one commuter;
translating the one or more changes into a point value based on the set of criteria for measuring the commuting difficulty;
assessing a constancy of the one or more changes and translating the constancy into a point value based on the set of criteria for measuring the commuting difficulty;
for each of the at least one commuter, aggregating the point value of the one or more changes and the point value of the constancy into an aggregated point value over the period of time; and
outputting the aggregated point value for each of the at least one commuter.

20. The method of claim 19, wherein the constancy includes a duration of the one or more changes in commuting behavior or a maintaining of the change in commuting behavior after an event.

21. The method of claim 19, further comprising generating an interface for visualizing the aggregated point value for each of the at least one commuter at a current time.
